(19) United States
(12) Patent Application Publication
(10) Pub. No.: US 2025/0271272 A1
(43) Pub. Date: Aug. 28, 2025

(54) METHOD FOR DETERMINING THE POSITION OF A WORK VEHICLE IN A SILO FACILITY

(71) Applicant: Deere & Company, Moline, IL (US)

(72) Inventors: Stefan Brocke, Mannheim (DE); Danesh R. Gandhi, Pune (IN)

(21) Appl. No.: 19/042,421

(22) Filed: Jan. 31, 2025

(30) Foreign Application Priority Data
Feb. 23, 2024 (EP) 24159317.7

(51) Int. Cl. G01C 21/20; G01C 21/16; G06F 16/29

(52) U.S. Cl. CPC G01C 21/206; G01C 21/165; G06F 16/29

(57) ABSTRACT

A method for determining the position of a work vehicle in a silo facility including detecting via a detection device associated with the work vehicle at least one stationary identification feature, looking up via a control unit on the basis of the at least one stationary identification feature from a database a position associated therewith with respect to a predetermined reference position inside the silo facility including a number of bunker silos, calculating via the control unit a spatial location of the work vehicle relative to the stationary at least one identification feature, setting via the control unit the spatial location by comparison with the looked-up position of the at least one stationary identification feature with respect to the predetermined reference position, and outputting via the control unit the spatial location as the current position of the work vehicle.

### CROSS-REFERENCE TO RELATED APPLICATIONS

This application claims priority to European Patent Application No. 24159317.7, filed Feb. 23, 2024, which is hereby incorporated by reference.

### FIELD OF THE DISCLOSURE

The disclosure relates to a method for determining the position of a work vehicle in a silo facility.

### BACKGROUND

The production and storage of silage, i.e. fermented green waste which is used in livestock farming for feeding in particular ruminants or also horses, usually take place in so-called bunker silos. The latter consist of an area bounded by concrete walls or wooden sleepers which is often open on one side such that a work vehicle can drive on the bunker silo in order to supply or remove the green waste and also to distribute or compact it in a targeted fashion when creating the bunker silo.

### SUMMARY

On larger farms, it is quite common that a number of bunker silos for storing various materials are combined in a silo facility, wherein the silo facility is often situated in a covered area or in a storehouse in order to protect the materials stored therein from the effects of the weather. Quickly finding a specific bunker silo or silo content when driving a work vehicle can be made more difficult in the case of larger silo facilities especially for employees who are not familiar with the silo facility.

The object of the present disclosure is therefore to provide a method of the type mentioned at the beginning which facilitates orientation within a silo facility including a number of bunker silos when a work vehicle is driven on it.

This object is achieved by a method having the features of the one or more embodiments disclosed herein.

The method for determining the position of a work vehicle in a silo facility provides that, by means of a detection device associated with the work vehicle, at least one stationary identification feature is detected and, on the basis of the detected identification feature, a position associated therewith with respect to a predetermined reference position inside the silo facility including a number of bunker silos is looked up by a control unit (e.g., a controller including a processor and memory) from a database, wherein in addition a spatial location of the work vehicle relative to the identification feature is calculated by means of the detection device and is set by comparison with the looked-up position of the identification feature with respect to the predetermined reference position and output as the current position of the work vehicle via a data interface. The current position of the work vehicle is determined for example periodically when driving on the silo facility, wherein the route covered here can be recorded in the database connected to the control unit.

The position determined in this way and output via the data interface simplifies orientation when driving on even larger silo facilities. The determination also takes place independently of external information, such as for example GPS data, which is not available, or only incompletely available, when satellite reception is compromised. Accordingly, it is irrelevant whether the silo facility is situated in the open air or is housed below a covered area or in a closed storehouse.

The identification feature is typically an optical marking or an optical identification marker in the form of a QR code which can be attached to a sign, or is a radio beacon. When a sign is used, this can be fastened to a silo or building structure or be free-standing on a stand. A stereo camera, a 3D scanner, or alternatively in the case of a radio beacon a corresponding radio receiver, can serve to detect the identification feature. The radio beacon has the advantage that it is largely not susceptible to deposits of dust and dirt or structural obstacles which can affect the visibility of optical markings. An optical marking can, however, be produced particularly cost-effectively and be replaced easily in the event of damage. The location of the work vehicle relative to the identification feature is detected here by evaluating the spatial information supplied by the stereo camera or the 3D scanner or the direction-or distance-dependent transit times, detected by radio receiver, of the beacon signals emitted by the radio beacon.

The silo facility usually includes a number of different bunker silos in which the various materials are stored. Examples of the latter are silage, i.e. green waste (chopped-up corn plants, thin-stemmed cut material such as grass or alfalfa) to be silaged, but also any other stored material (seeds, fertilizer granules, road salt). A comprehensive spatial organization of the bunker silos is possible by the appropriate placement or assignment of a sufficient number of identification features inside the silo facility, which makes it easier to find a specific bunker silo or silo content, and also creates the possibility of performing automated processing functions on the basis of the specific current position of the work vehicle. These automated processing functions include assistance functions which support for example the supply or removal of material by means of a front or bucket loader, but also carrying out a distribution or compacting procedure when creating the bunker silo by means of a pusher blade attached to an agricultural tractor. In order to plan and carry out the distribution and compacting procedure accurately, already processed areas can here be taken into account by including the route recorded in the database. If a plurality of identification features are present, not only can the accuracy of the position determination be further increased by data fusion but it can also be ensured by their intelligent placement taking into account the structural circumstances that at least one of the identification features is always within the visual or reception range of the detection device.

Advantageous developments of the method according to the disclosure can be found in the one or more embodiments disclosed herein.

The current position of the work vehicle is for example output in local coordinates relative to the predetermined reference position. This enables the use of a coordinate system which is specific for the respective silo facility and freely configurable such that the respective spatial circumstances of the silo facility can correspondingly be taken into account by the operator. The configuration can here be effected via a touch-sensitive display which is included in a user interface connected to the control unit.

It is furthermore possible that the current position of the work vehicle, output by the control unit, is transformed into global coordinates. The selection of a corresponding coordinate system, as used by a GPS navigation system present in the work vehicle, can be made by the operator via the touch-sensitive display of the user interface. In this case, one and the same coordinate system can be used both inside and outside the silo facility.

It is conceivable here that the transformed current position of the work vehicle is used to correct localization discrepancies of the GPS navigation system. This enables determination of the position of the work vehicle inside the silo facility to be made on the basis of GPS data received by means of the GPS navigation system, even when this data is temporarily not available or only incompletely available when satellite reception is compromised. The localization accuracy when driving outside the silo facility is also correspondingly improved at the same time.

It can also be provided that associated with the identification feature is at least one localization criterion of a bunker silo identified therewith inside the silo facility, for example in terms of a silo reference position, a silo content (type and quality of the material stored therein), a silo characteristic (state of compaction, filling level, material distribution, compaction process), the type of processing measures being carried out (supply, removal, distribution, compaction), a processing time point (time of day, day, month, year), and/or further criteria (name of the person in charge, machines used). The relevant localization criteria are used to provide a better overview of the silo facility and can be saved in the database connected to the control unit. In particular knowledge of the respective silo reference position here enables the driver of the work vehicle to navigate to a bunker silo, selected by them (on the basis of the localization criteria), inside the silo facility by the output of corresponding driving instructions via the touch-sensitive display included in the user interface.

In order to further improve the accuracy of the position determination, the calculation of the spatial location of the work vehicle relative to the identification feature can be compensated by the control unit in terms of an incorrect angular position of the work vehicle, detected by sensors. The detection of the incorrect angular position by sensors is effected, for example, by means of an inertial measurement unit (IMU) arranged in the work vehicle by measuring pitching about a transverse axis and/or rolling about a longitudinal axis of the work vehicle.

The above and other features will become apparent from the following detailed description and accompanying drawings.

### BRIEF DESCRIPTION OF THE DRAWINGS

The method according to the disclosure will be explained in more detail hereinafter on the basis of the appended drawings, in which:

FIG. 1 shows an example embodiment of the method according to the disclosure for determining the position of a work vehicle, in the form of an agricultural tractor, in a silo facility;

FIG. 2 shows an example of an arrangement for carrying out the method illustrated in FIG. 1; and

FIG. 3 shows a silo facility including a number of bunker silos.

### DETAILED DESCRIPTION

The embodiments or implementations disclosed in the above drawings and the following detailed description are not intended to be exhaustive or to limit the present disclosure to these embodiments or implementations.

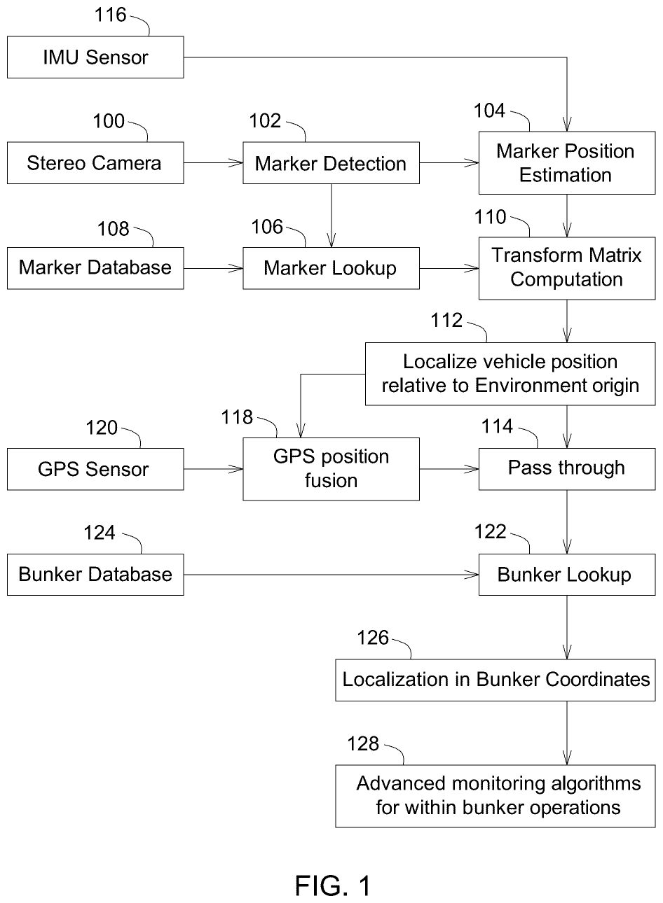

FIG. 1 shows an example embodiment, illustrated as a flow chart, of the method according to the disclosure for determining the position of a work vehicle, in the form of an agricultural tractor, in a silo facility,

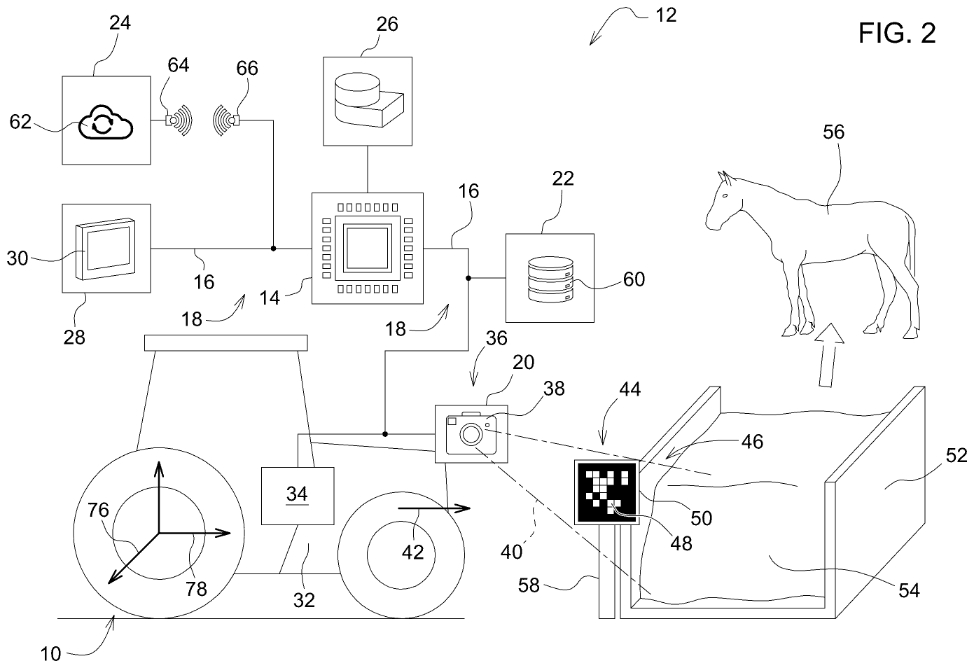

For better understanding, the arrangement illustrated schematically in FIG. 2, which serves to carry out the method according to FIG. 1, will first be discussed.

The arrangement 12 situated in the agricultural tractor 10 has a microprocessor-controlled control unit 14 which is connected via a data interface 18 in the form of a CAN data bus 16 to a detection device 20, a first database 22, a second database 24, a GPS navigation system 26, a user interface 28 with a touch-sensitive display 30, and an inertial measurement unit (IMU) 34 firmly attached to a tractor chassis 32.

The detection device 20 is a stereo camera 38, associated with the front area 36 of the agricultural tractor 10, the visual or reception range 40 of which is oriented in the direction of a forward driving movement 42 of the agricultural tractor 10 in order to detect a stationary identification feature 44 which in the present case is an optical marking or an optical identification marker 46 in the form of a QR code 48 which is attached to a sign 50 which is situated, for example, next to a bunker silo 52 in which, for example, silage 54 for feeding ruminants or horses 56 is stored. The sign 50 is fastened to a silo or building structure or (as here) is free-standing on a stand 58. It should be noted that a 3D scanner or the like can also be used to detect the identification feature 44 instead of a stereo camera 38.

As can moreover be seen in FIG. 2, the first database 22 is formed by a local store 60, whereas the second database 24 is formed by an external (cloud-based) data server 62, wherein the latter is connected to the control unit 14 via a wireless communications interface 64, 66.

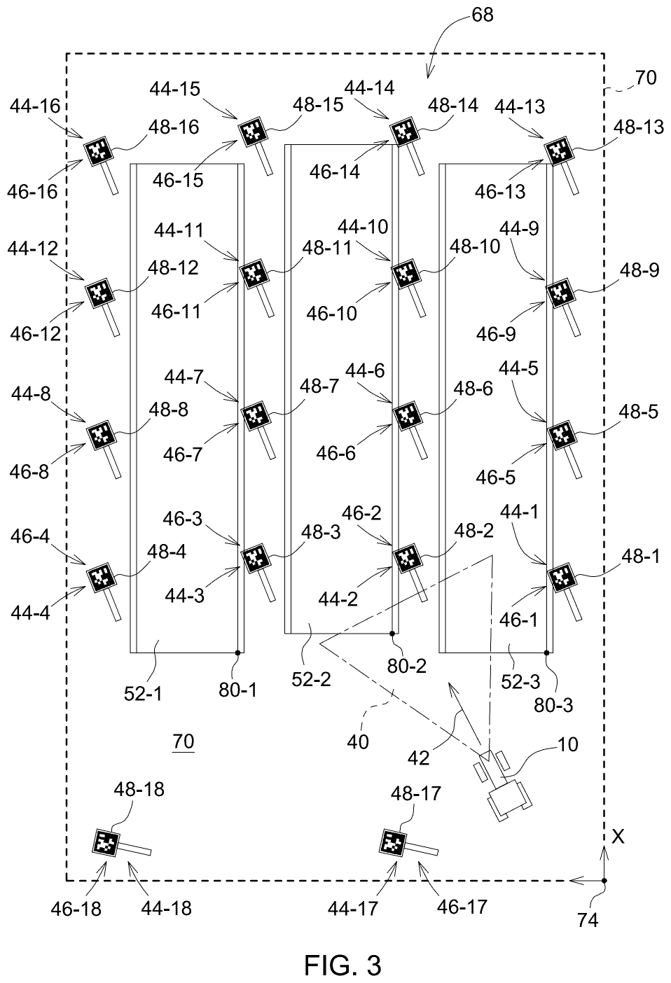

FIG. 3 shows a silo facility 68 including a number of bunker silos 52-1, 52-2, 52-3. The silo facility 68 is housed below a covered area or in a closed storehouse 70 in order to protect the materials stored in the bunker silos 52-1, 52-2, 52-3 from the effects of the weather. Alternatively, the silo facility 68 can also be situated in the open air.

Each of the bunker silos 52-1, 52-2, 52-3 includes an area, bounded by concrete walls or wooden sleepers, which is open on one side such that the agricultural tractor 10 can drive on the bunker silo 52-1, 52-2, 52-3 for the purpose of removing and supplying material as well as distributing or compacting it in a targeted manner. To do this, a front loader or a pusher blade (not shown) is attached to the agricultural tractor 10.

The various materials are stored in the bunker silos 52-1, 52-2, 52-3. Examples of these materials are silage, i.e. green waste (chopped-up corn plants, thin-stemmed cut material such as grass or alfalfa) to be silaged, but also any other stored material (seeds, fertilizer granules, road salt).

In contrast to the illustration in FIG. 1, a number of identification features 44-1 to 44-18 in the form of optical markings or optical identification markers 46-1 to 46-18 with in each case an individual QR code 48-1 to 48-18 are attached or erected within the whole covered area or the closed storehouse 70 along the bunker silos 52-1, 52-2, 52-3 and within a forecourt 72 provided for parking the agricultural tractor 10. The identification features 44-1 to 44-18 are placed, taking into consideration the structural circumstances, in such a way that at least one of the identification features 44-1 to 44-18 is always in the visual or reception range 40 of the detection device 20 as long as the agricultural tractor 10 is situated inside the silo facility 68. In the present example, these are the identification features 44-1, 44-2, 44-3.

Alternatively, the identification features 44-1 to 44-18 take the form of radio beacons. The detection device 20 is then a radio receiver (not shown) associated with a front area 36 of the agricultural tractor 10. Radio beacons have the advantage that they are largely not susceptible to deposits of dust and dirt or structural obstacles which can affect the visibility of optical markings. Optical markings can, however, be produced particularly cost-effectively and be replaced easily in the event of damage.

In the method performed by the control unit 14 and saved in the local store 60 as a corresponding program code, according to FIG. 1 the detection device 20 is put into operation in a first main step 100 with a self-test being carried out in order, in a second main step 102, to detect the identification features 44-1, 44-2, 44-3 situated in its visual or reception range 40, and, in a third main step 104, additionally to calculate a spatial location of the agricultural tractor 10 relative to each of the detected identification features 44-1, 44-2, 44-3. This takes place by evaluating the spatial information supplied by the stereo camera 38 or the 3D scanner or the direction-or distance-dependent transit times, detected by radio receiver, of the beacon signals emitted by the radio beacons.

In a fourth main step 106, on the basis of the identification features 44-1, 44-2, 44-3 detected in the second main step 102, a position associated in each case with said identification features with respect to a predetermined reference position 74 inside the silo facility 68 is calculated by the control unit 14, which takes place by looking up, in a first sub-step 108, a dataset saved in the local store 60 or the external data server 62. The dataset is here created as part of the placement or attachment of the identification features 44-1 to 44-18, for which purpose their respective position with respect to the selected reference position 74 is determined using suitable means.

After that, the spatial location, calculated in each case in the third main step 104, of the agricultural tractor 10 relative to the detected identification features 44-1, 44-2, 44-3 is, by comparison with the looked-up position of the relevant identification feature 44-1, 44-2, 44-3, set in a fifth main step 110 with respect to the predetermined reference position 74 and output in a sixth main step 112 as the current position of the agricultural tractor 10 via the CAN data bus 16 in a seventh main step 114. This takes place separately for each of the detected identification features 44-1, 44-2, 44-3, wherein the accuracy of the position determination can be further increased by data fusion. The position determined in this way can here relate to any desired point on the agricultural tractor 10 including to its center of gravity in the unloaded state or the location of the inertial measurement unit 34.

In addition, the calculation of the spatial location of the agricultural tractor 10 relative to the detected identification features 44-1, 44-2, 44-3 is compensated in the third main step 104 by the control unit 14 in terms of an incorrect angular position of the agricultural tractor 10, detected by sensors. The detection of the incorrect angular position by sensors is effected in a second sub-step 116 by means of the inertial measurement unit 34 arranged in the agricultural tractor 10 by measuring pitching about a transverse axis 76 and/or rolling about a longitudinal axis 78 of the agricultural tractor 10.

The outputting or supplying of the current position of the agricultural tractor 10 takes

place in the seventh main step 114 in local coordinates relative to the predetermined reference position 74. Underlying this is the use of a coordinate system which is specific for the respective silo facility 68 and freely configurable such that the respective spatial circumstances of the silo facility 68 can correspondingly be taken into account by the operator. The configuration takes place here via the touch-sensitive display 30 of the user interface 28 connected to the control unit 14.

Additionally, in the seventh main step 114, the current position of the agricultural tractor 10 output by the control unit 14 is transformed into global coordinates. The selection of a corresponding coordinate system, which is used at the same time by the GPS navigation system 26 present in the agricultural tractor 10, can be made by the operator via the touch-sensitive display 30 of the user interface 28. In this case, one and the same coordinate system can be used both inside and outside the silo facility 68.

The current position, transformed in this way, of the agricultural tractor 10 is

additionally used in a third sub-step 118 to correct localization discrepancies of the GPS navigation system 26. This enables determination of the position of the agricultural tractor 10 inside the silo facility 68 to be made on the basis of GPS data received by means of the GPS navigation system 26 in a fourth sub-step 120, even when this data is temporarily not available or only incompletely available when satellite reception is compromised. The localization accuracy when driving outside the silo facility 68 is also correspondingly improved at the same time.

The method illustrated in FIG. 1 is carried out, and thus the current position of the agricultural tractor 10 is determined, periodically when driving on the silo facility 68, wherein the route covered here is recorded in the local store 60 connected to the control unit 14.

Furthermore, associated with the identification features 44-1, 44-2, 44-3 attached or erected along the bunker silos 52-1, 52-2, 52-3 is at least one localization criterion of a bunker silo 52-1, 52-2, 52-3 identified thereby inside the silo facility 68, for example in terms of a silo reference position 80-1, 80-2, 80-3, a silo content (type and quality of the material stored therein), a silo characteristic (state of compaction, filling level, material distribution, compaction process), the type of processing measures being carried out (supply, removal, distribution, compaction), a processing time point (time of day, day, month, year), and/or further criteria (name of the person in charge, machines used). The relevant localization criteria are used to provide a better overview of the silo facility 68 and are saved in the local store 60 or external data server 62 as a corresponding dataset. In an eighth main step 122, the driver of the agricultural tractor 10 has the possibility of selecting, on the basis of the localization criteria supplied in a fifth sub-step 124, a specific one of the bunker silos 52-1, 52-2, 52-3, the silo reference position 80-1, 80-2, 80-3 of which is then calculated in a subsequent ninth main step 126. Knowledge of the respective silo reference position 80-1, 80-2, 80-3 forms, in conjunction with the current position of the agricultural tractor 10 output or supplied in the seventh main step 114, the basis for the driver of the agricultural tractor 10 to navigate in a tenth main step 128 to the selected bunker silo 52-1, 52-2, 52-3 inside the silo facility 68 by the output of corresponding driving instructions via the touch-sensitive display 30 included in the user interface 28.

A comprehensive spatial organization of the bunker silos 52-1, 52-2, 52-3 is possible by the appropriate placement or assignment of a sufficient number of identification features 44-1 to 44-18 inside the silo facility 68 such that, on the basis of the current position of the agricultural tractor 10 output or supplied in the seventh main step 114, not only is it made easier to find a specific bunker silo 52-1, 52-2, 52-3 or silo content, but there is also the possibility of performing automated processing functions. The latter assistance functions include assistance functions which support for example the supply or removal of material, but also carrying out a distribution and compacting procedure when creating the bunker silo 52-1, 52-2, 52-3. In order to plan or carry out the distribution and compacting procedure accurately, already processed areas can here be taken into account by including the route recorded in the local store 60.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for determining the position of a work vehicle in a silo facility, comprising:
detecting via a detection device associated with the work vehicle at least one stationary identification feature;
looking up via a control unit on the basis of the at least one stationary identification feature from a database a position associated therewith with respect to a predetermined reference position inside the silo facility including a number of bunker silos;
calculating via the control unit a spatial location of the work vehicle relative to the at least one stationary identification feature;
setting via the control unit the spatial location by comparison with the looked-up position of the at least one stationary identification feature with respect to the predetermined reference position; and
outputting via the control unit the spatial location as the current position of the work vehicle, the control unit connected via a data interface to the detection device, the database, and a user interface.

2. The method of claim 1, wherein the current position of the work vehicle is output in local coordinates relative to the predetermined reference position.

3. The method of claim 1, wherein the current position of the work vehicle, output by the control unit, is transformed into global coordinates.

4. The method of claim 3, wherein the transformed current position of the work vehicle is used to correct localization discrepancies of a GPS navigation system connected to the control unit via the data interface.

5. The method of claim 1, wherein associated with the at least one stationary identification feature is at least one localization criterion of a bunker silo identified therewith inside the silo facility.

6. The method of claim 5, wherein the at least one localization criterion includes one or more of a silo reference position, a silo content, a silo characteristic, and a type of processing measures being carried out.

7. The method of claim 1, wherein the calculation of the spatial location of the work vehicle relative to the at least one stationary identification feature is compensated by the control unit in terms of an incorrect angular position of the work vehicle, measured by an inertial measurement unit connected to the control unit via the data interface.

8. The method of claim 1, further comprising determining via the control unit the current position of the work vehicle periodically when driving on the silo facility and recording the route in the database.

9. A system for determining the position of a work vehicle in a silo facility, comprising:
a detection device associated with the work vehicle configured to detect at least one stationary identification feature; and
a control unit configured to look up on the basis of the at least one stationary identification feature from a database a position associated therewith with respect to a predetermined reference position inside the silo facility including a number of bunker silos, the control unit configured to calculate a spatial location of the work vehicle relative to the at least one identification feature, the control unit configured to set the spatial location by comparison with the looked-up position of the at least one identification feature with respect to the predetermined reference position, and the control unit configured to output the spatial location as the current position of the work vehicle via a data interface.

10. The system of claim 9, wherein the current position of the work vehicle is output in local coordinates relative to the predetermined reference position.

11. The system of claim 9, wherein the current position of the work vehicle, output by the control unit, is transformed into global coordinates.

12. The system of claim 9, wherein the transformed current position of the work vehicle is used to correct localization discrepancies of a GPS navigation system connected to the control unit via the data interface.

13. The system of claim 9, wherein associated with the at least one stationary identification feature is at least one localization criterion of a bunker silo identified therewith inside the silo facility.

14. The system of claim 13, wherein the at least one localization criterion includes one or more of a silo reference position, a silo content, a silo characteristic, and a type of processing measures being carried out.

15. The system of claim 9, wherein the calculation of the spatial location of the work vehicle relative to the at least one stationary identification feature is compensated by the control unit in terms of an incorrect angular position of the work vehicle, measured by an inertial measurement unit connected to the control unit connected to the control unit via the data interface.

16. The system of claim 9, wherein the control unit is configured to determine the current position of the work vehicle periodically when driving on the silo facility and recording the route in the database.
